(19) United States
(12) Patent Application Publication
(10) Pub. No.: US 2021/0274608 A1
(43) Pub. Date: Sep. 2, 2021

(54) Cooking Device

(71) Applicant: Andrew Clive Wright, Sale (GB)

(72) Inventor: Andrew Clive Wright, Sale (GB)

(21) Appl. No.: 17/257,287

(22) PCT Filed: Jul. 3, 2019
(86) PCT No.: PCT/EP19/67913

§ 371 Date: Dec. 30, 2020

(30) Foreign Application Priority Data
Jul. 3, 2018 (GB) 1810920.7
Feb. 5, 2019 (GB) 1901594.0

(51) Int. Cl. H05B 6/64; A47J 36/02; H05B 7/16; H05H 1/46

(52) U.S. Cl. CPC H05B 6/647; A47J 36/027; H05H 1/461; H05B 7/16; H05B 6/6408

(57) ABSTRACT

A cooking device for frying food in a microwave oven, the cooking device comprising a low pressure gas chamber; a plasma igniting means configured to ignite plasma within the low pressure gas chamber when supplied with microwave radiation; and a cooking enclosure formed of metal, the cooking enclosure defining a food-receiving region and being thermally coupled to the low pressure gas chamber.

### FIELD OF THE INVENTION

The present invention relates to a cooking device for frying food in a microwave oven.

### BACKGROUND

Electromagnetic waves in the microwave region in the spectrum have, following its invention in 1945 by Percy Spencer (U.S. Pat. No. 2,495,429, published 1950), been used commercially to heat food since its introduction in 1954 by the Raytheon® company and the microwave oven is now a common appliance in many domestic kitchens with over 90% of homes in the US owning a microwave oven. Recent developments by the Japanese firm Panasonic® have seen the addition of both a steaming facility and a conventional convection oven mode making the modern microwave a very versatile cooking system. However, microwave energy does not cause selective browning of the outer surface of the food and this has led to the development of microwave oven with an additional grill to facilitate this function. It will be known by anyone who has attempted to cook burgers in a standard (non-grill) microwave oven that the result is a grey, greasy rather unpleasant affair which is not at all palatable.

The most common implementation of the grill in these combination ovens is via the use of linear quartz-halogen lamps hidden behind a metal mesh in the cavity roof which emit sufficient infrared radiation to cause browning of the food. An interesting further development of the radiant lamp concept is the use of a plasma lamp as described in US Pat. 629,7485 (2001, now lapsed). The plasma lamp itself is a linear tube of silica glass filled with gas at low pressure and is energized into ionization by the microwave energy itself. The electric field intensity inside a microwave oven cavity is sufficiently intense so as to convert the low pressure gas of these lamps into a gas plasma state. The heat from the internal plasma provides a source of radiant infrared emission and has the advantage of having no internal tungsten filament to burn out thereby attaining a very long working life.

Plasma is known as the Fourth State of Matter in which gas is partly ionised i.e. partly stripped of electrons so that the gas then becomes electrically conductive. Plasma lamps are also called gas-discharge lamps and a well-known example is the neon lamp. Plasma can mean either an electrical gas-discharge or the fourth state of matter.

However, these linear lamps are always placed in the roof of the microwave oven and are thus some distance away from the food to be browned. Also, some of the output power of the plasma is not in the infrared part of the electromagnetic spectrum that is responsible for heating effects and thus the power of the browning effect is limited. It is also not possible to sear the surface of meat as might be achieved by the use of a hot frying pan surface and so the creation of cooked hamburgers with a rare-cooked interior and seared exterior is not possible with standard browning lamps in microwave ovens. Instead, these so-called combination ovens tend to overcook the inside of the meat. Like all grills, the time for cooking can be rather long and the sales of combination microwave ovens are much lower than that of a standard microwave oven having no grill.

Over the years, various susceptor skillets have been produced made of a metallic, ceramic, or earthenware material coated with a special resistive susceptor layer which is able to convert the electromagnetic field into heat by resistive losses. However, these products have to be first pre-heated in the oven and only then after removal from the oven can the food to be cooked be placed on the skillet for a second heating period back in the oven. This two-step process is somewhat tiresome for the user. The susceptor layer material can also be rather fragile and so washing can cause damage. Many of the susceptor skillets also do not reach the temperatures required for proper frying or searing of meat. Further, tests of one of these commercial offerings by the author using a new microwave oven of nominal output power of 700W show that the absorbed power drops from 592W to 535W after only two 2 minute runs of the browning/frying plate and only a slight heating (30° C.) of the fryer plate. By contrast, he glass turntable itself had become much hotter (>50° C.).

Thus no effective cooking device yet exists for frying food in a microwave oven.

### SUMMARY OF THE INVENTION

A first aspect of the present invention provides a cooking device for frying food in a microwave oven, the cooking device comprising: a low pressure gas chamber; a plasma igniting means configured to ignite plasma within the low pressure gas chamber when supplied with microwave radiation; and a cooking enclosure formed of metal, the cooking enclosure defining a food-receiving region and being thermally coupled to the low pressure gas chamber.

When the device is in a functioning microwave oven, microwave radiation will cause the plasma igniting means to ignite plasma in the low pressure gas chamber. Heat from the plasma will then be transferred by conduction to the metal cooking enclosure and then to the food-receiving region. The device can operate as a stand-alone unit that can be taken out of a standard microwave oven for cleaning or when the microwave oven is simply to be used in its normal mode of operation.

The plasma attains a very high temperature and so enough heat is transferred to the metal cooking enclosure to cause frying of food in the food-receiving region.

The metal cooking enclosure shields the food-receiving region from microwaves, thereby reducing the amount of microwave radiation that food in the food receiving region absorbs so that more of the microwave radiation is available to ignite the plasma.

The term thermally coupled means that the components are arranged so as to allow heat to travel by conduction from one component to the other.

The plasma igniting means may be a microwave resonator proximal to or within the low pressure gas chamber. The microwave resonator acts to increase the electric field strength in the vicinity of the low pressure gas chamber thereby providing enough energy in the chamber to ignite plasma.

The microwave resonator may comprise two metal reflector plates spaced apart from one another. In this way, a localized standing wave pattern is set up, thereby increasing the field strength in the region of the low pressure gas chamber, facilitating ignition of plasma. The plates may be spaced an integer number of half-wavelengths apart in order to increase the effect of the plates on the electric field. The exact length of one wavelength will depend on the materials and sizes of components placed between the plates. For example, the thickness of the walls of the low pressure gas chamber will affect the electrical length of one wavelength. The metal plates may be spaced 6 cm±1 cm apart from one another (around half a wavelength of the radiation used in microwave ovens) or spaced 12 cm±1 cm apart from one another (around one wavelength). The frequency of microwave radiation in conventional domestic microwave ovens is 2450 MHz.

The low pressure gas chamber may be positioned between the two metal reflector plates. This arrangement ensures that at least one antinode (or peak) of the standing wave is located within the low pressure gas chamber, thereby further ensuring that the electric field within the low pressure gas chamber is increased. Preferably, the low pressure gas chamber may be positioned so that the point midway between the centres of each of the two reflector plates is within the low pressure gas chamber.

The microwave resonator may comprise a metal wire. The wire facilitates ignition of the plasma.

The wire may have a thermal expansivity matching a thermal expansivity of a wall of the low pressure gas chamber. In this way, defects (cracks) in the wall of the low pressure gas chamber and/or the wire due to thermal expansion and contraction can be avoided. Preferably, the thermal expansivity of the wire and the wall of the low pressure gas chamber are within 50% of each other so that they match one another, more preferably, the thermal expansivity of the wire and the wall of the low pressure gas chamber are within 10% of each other. For example, if the walls of the low pressure gas chamber are formed of borosilicate glass, the wire may be formed of Kovar™ (FerNiCo I). The wire may be formed of silver or silver plated copper. For some grades of borosilicate glass exhibiting a high softening point and the lowest thermal expansivity, tungsten or more preferably, gold plated tungsten wire, is more appropriate as the igniter wire. The use of gold plating has the advantage of being non-wettable by glass when molten. The gold plating also has the additional benefit of a higher electrical conductivity than tungsten thus reducing ohmic heating effects due to the skin effect at microwave frequencies.

The wire may have a length of at least 3 cm±1.5 cm. The wire may be at least a quarter of a wavelength long so as to better facilitate ignition of plasma due to an antinode occurring at one or both ends of the wire. For example, in a wire one quarter of a wavelength long, a low voltage node may exist at one end and a high voltage antinode may exist at the other end. In a wire of half a wavelength long, a low voltage node may exist at the centre of the wire and high voltage antinodes may exist at both ends.

The wire may lie along an inner wall of the low pressure gas chamber or may be embedded in a wall of the low pressure gas chamber. One end of the wire may be exposed to the inside of the low pressure gas chamber to facilitate ignition of the plasma.

The cooking enclosure may comprise a metal frying plate on top of the low pressure gas chamber and a metal cover locatable on the metal frying plate to enclose the food-receiving region. The food may be placed on the metal plate and the cover may be placed over the food so that edges of the cover makes physical contact with the plate and the food is effectively shielded from microwaves.

The metal frying plate may form one of the two metal reflector plates. This reduces the number of components needed in the device.

The metal frying plate may be in direct contact with the low pressure gas chamber. Thus heat can be transferred by conduction directly from the low pressure gas chamber to the metal plate by conduction.

The cooking device may further comprise a glass plate located between the low pressure gas chamber and the metal frying plate, wherein the glass plate contacts the low pressure gas chamber and the metal frying plate. The extra plate facilitates a means of temperature control by either increasing the thermal resistance (offering a means of temperature reduction) between the hot plasma and the fryer plate or by increasing absorption of infra-red (offering a means of additional temperature increase) by using an appropriate grade of heat absorbing glass. This glass plate reduces the effects of differing thermal expansivities between two different grades of glass. For better temperature reduction, the extra glass plate may be perforated with holes to create insulating air pockets.

The shape of a surface of the metal frying plate may conform to the shape of an outer surface of the low pressure gas chamber. This improves conduction between the low pressure gas chamber and the metal frying plate.

The metal frying plate may have a sunken region for collecting liquid. Fat produced during frying can collect in the sunken portion making cleaning easier and reducing the fat content of the cooked food. Further, the collected fat will not drip out of the cooking enclosure where it could absorb microwaves and reduce the power provided to the plasma. The sunken region may be continuous so as to surround a surface on which food can be placed. The sunken region does not need to be at the edge of the metal plate.

The metal frying plate may have one or more sunken sausage-receiving portions having a rounded half-cylindrical shape. Other frying plates may be provided with food-specific sunken portions to facilitate even cooking of the food. For example, a portion of the metal frying plate may be shaped to allow waffles to be made from batter mixture. The sunken food-specific portion allows the metal frying plate to contact more of the surface of the food leading to more even frying of the food.

The metal cover may have a continuously curved shape. This reduces the chance of arcing or micro discharges (sparks) occurring as a result of the intensified electric field as occurs if a sharp metal object, e.g. fork or spoon is inadvertently left in an operating microwave. This reduces energy dissipation leading to more successful ignition of the plasma.

The shape of the cover may have no corners. For example, the metal cover may be a hollow domed shape. The shape of the cover may be a portion of a sphere, for example a hemisphere or the curvature may vary over the cover.

A portion of the metal cover configured to contact the metal frying plate so as to form the enclosed food-receiving region may have an insulating coating. This reduces the chance of arcing occurring where the metal cover contacts the metal frying plate.

The metal cover may have a hole for allowing water vapour to escape the food-receiving region, the hole having a maximum width of 1 mm. The hole ensures that excess steam does not build up in the cooking enclosure. The hole is small enough that the food-receiving region remains effectively shielded from microwaves. There may be a plurality of such holes in order to allow more water vapour to escape.

The metal frying plate and/or the metal cover may comprise aluminium or an aluminium alloy or silver. The metal frying plate and/or the metal cover may be formed of stainless steel and coated with silver or aluminium for better electrical conductivity. The metal frying plate and/or the metal cover may also be Teflon® coated.

The low pressure gas chamber is filled with gas having a pressure of 0.25 to 10 millibar. The low pressure gas chamber may be filled with air, or nitrogen, or oxygen, or argon, or a mixture of air and argon, or a mixture of nitrogen and argon. Walls of the low pressure gas chamber may have a thickness of at least 3 mm. Walls of the low pressure gas chamber may be formed of glass or a glass ceramic. Walls of the low pressure gas chamber may be formed of Borosilicate glass. The low pressure gas chamber may have an internal height of at least 1.5 cm, or more preferably, an internal height of at least 3 cm.

The low pressure gas chamber may be encapsulated in a high-temperature-resistant thin film. This ensures that if the low pressure gas chamber were to break then the walls are contained within the high-temperature-resistant thin film reducing the risk of injury caused by fragments of the low pressure gas chamber walls.

The cooking device may further comprise a base formed of dielectric material, and the low pressure gas chamber and the plasma igniting means may be secured to the base. One of the metal reflector plates may be bonded to or embedded within the base. The cooking device may further comprise a safety shroud formed of silicone rubber or fluoropolymer, or glass, wherein the base, the safety shroud and the cooking enclosure form an enclosure around the low pressure gas chamber. The base and the safety shroud may be formed by a single integral piece, which may be formed of glass.

The cooking device may be configured so that it can be disassembled for cleaning or storage. The low pressure gas chamber, igniting means, metal frying plate, base and safety shroud may be provided as a unit and the cover may be provided as a separate unit. Alternatively, the low pressure gas chamber, igniting means, base and safety shroud may be provided as a unit and the metal cooking enclosure may be provided as one or more separate units.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is an exploded view of a cooking device having a low pressure gas chamber, a metal frying plate with a fat draining trench and a cover-locating groove and a metal domed cover with a plastic offset knob.

FIG. 2A is a side view of a low pressure gas chamber.

FIG. 2B is a perspective, underside view of the low pressure gas chamber of FIG. 2A.

FIG. 2C is a perspective view of a section of the low pressure gas chamber of FIG. 2A.

FIG. 2D is a cross-sectional view of the low pressure gas chamber of FIG. 2A.

FIGS. 2E to 21 show further examples of low pressure gas chambers.

FIG. 3A shows a perspective view of a low pressure gas chamber having an internal support tube.

FIG. 3B shows a cross-sectional view of the low pressure gas chamber of FIG. 3A.

FIG. 4A shows a cross-sectional view of an example cooking device.

FIG. 4B shows a 3D section view of the cooking device of FIG. 4A.

FIG. 5A shows a perspective view of an example metal frying plate.

FIG. 5B shows a cross-sectional view of the metal frying plate of FIG. 5A.

FIG. 5C perspective view of a section of the example metal frying plate of FIG. 5A.

FIG. 5D shows a perspective underside view of the example metal frying plate of FIG. 5A.

FIG. 6A shows a perspective view of another example metal frying plate.

FIG. 6B shows a cross-sectional view of the metal frying plate of FIG. 6A.

FIG. 7A shows a metal domed cover with an offset knob.

FIG. 7B shows a perspective view of the knob shown in FIG. 7A.

FIG. 7C shows a cross-sectional view of the knob of FIG. 7B.

FIG. 8 shows an exploded view of a metal frying plate and a corresponding low pressure gas chamber adapted for cooking sausages.

FIG. 9 shows a cross-sectional view of a metal frying plate and a corresponding low pressure gas chamber adapted for cooking waffles from batter.

FIG. 10A shows a perspective view of an example cooking device.

FIG. 10B shows a cross-sectional view of the cooking device of FIG. 10A.

FIG. 10C shows an enlarged view of the portion of FIG. 10B where the shroud, metal frying plate, metal cover and low pressure gas chamber meet.

FIG. 10D shows a perspective view of a low pressure gas chamber having a flange.

FIG. 10E shows a perspective underside view of the low pressure gas chamber of FIG. 10D.

FIG. 10F shows a perspective view of a tabbed metal frying plate.

FIG. 10G shows a close-up view of the connection between the shroud and the metal frying plate of FIG. 10F.

FIG. 10H shows an enlarged cross-sectional view of the connection of FIG. 10G.

FIG. 11A shows a perspective view of an example cooking device (metal cover not shown).

FIG. 11B shows a cross-sectional view of the cooking device of FIG. 11A with a metal cover in place.

FIG. 11C shows an enlarged cross-sectional view of the connection between the low pressure gas chamber, metal frying plate, shroud and metal cover of the cooking device of FIG. 11B.

FIG. 12A shows a perspective view of an example cooking device (metal cover not shown).

FIG. 12B shows a cross sectional view of the cooking device of FIG. 12A.

FIG. 13A shows a perspective view of a low pressure gas chamber.

FIG. 13B shows a top view of the low pressure gas chamber of FIG. 13A.

FIG. 14 shows a side view of a metal domed cover with a centre knob for gripping with tongs.

FIG. 15A shows a perspective view of self-gripping tongs.

FIG. 15B shows a top view of the self-gripping tongs of FIG. 15A.

FIG. 16A shows a side view of the metal domed cover of FIG. 14 being gripped by the self-gripping tongs of FIG. 15A.

FIG. 16B shows a top view of the metal domed cover of FIG. 14 being gripped by the self-gripping tongs of FIG. 15A.

FIG. 16C shows a perspective view of the metal domed cover of FIG. 14 being gripped by the self-gripping tongs of FIG. 15A.

### DETAILED DESCRIPTION OF THE INVENTION

Aspects and embodiments of the present invention will now be discussed with reference to the accompanying figures. Further aspects and embodiments will be apparent to those skilled in the art.

In the following embodiments is described a way of utilizing the plasma heating effect to create a stand-alone device which can be placed inside a standard simple microwave oven (having no specialised grill or other electrical heating element already installed in the base or roof or walls of the cavity) that provides a frying or cooking effect for food. The central concept is to transfer the heat of gas plasma fluid in a low pressure gas chamber to the walls of the chamber and then by conduction to a metal frying plate 4 in thermal contact with the hot walls of the chamber. For best heat transfer, the outer surface of the chamber and the metal frying plate 4 are conformal to each other and in mechanical contact.

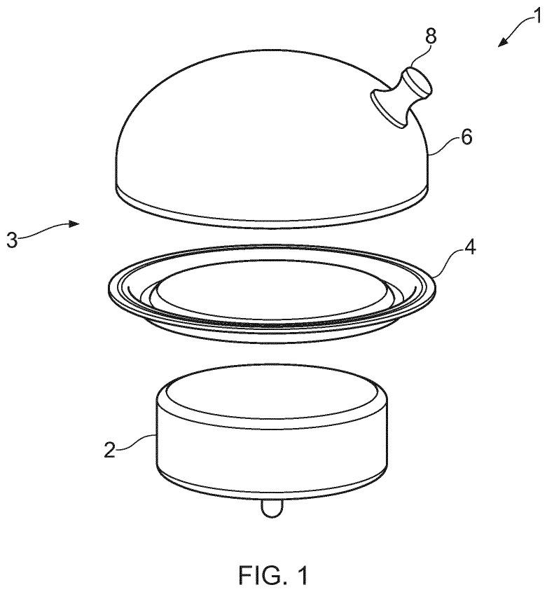

As shown in FIG. 1, cooking device 1 has a low pressure gas chamber 2, and a metal cooking enclosure 3 formed of a metal frying/fryer plate 4 and a metal cover 6. In use, the metal frying plate 4 is placed atop the low pressure gas chamber 2 so that heat produced in the low pressure gas chamber 2 is transferred by conduction to the metal frying plate 4 and food placed on the metal frying plate 4 can be cooked. The metal cover 6 is placed atop the metal frying plate 4 so as to shield food on the metal frying plate 4 from microwave radiation. The entire device, with food in place, can be loaded into a standard ordinary microwave without any modification to the latter. Once the microwave oven is turned on, microwave radiation causes plasma to be ignited in the low pressure gas chamber 2, producing heat that is transferred by conduction from the walls of the chamber 2 to the metal frying plate 4. Unlike normal resistive heated grill elements, the plasma in the low pressure gas chamber 2 responds instantly to input power and by the use of modern inverter technology the microwave energy can be properly controlled. This enables the frying/cooking effect to be finely controlled to ensure that food is not over cooked.

The metal cover 6 of FIG. 1 is domed and is located on the metal frying plate 4 by a locating groove 20 in the metal frying plate 4. The metal frying plate 4 also has a sunken fat draining trench 22.

The low pressure gas chamber 2 may be formed in a variety of shapes such as a tube in the shape of a tight spiral or as a closely folded rectangular meander such that it provides a concentrated heat source underneath the item to be cooked. However, in practice the simplest shape to manufacture and employ is that of a simple cylinder of glass somewhat larger in diameter than the object to be cooked. It is to be recognized that as an alternative to the cylindrical shape, a rectangular or other polygonal shape or irregular shape may be used to form the low pressure gas chamber. The low pressure gas chamber 2 may also have a seal-off nipple due to the process of evacuating the low pressure gas chamber during manufacture.

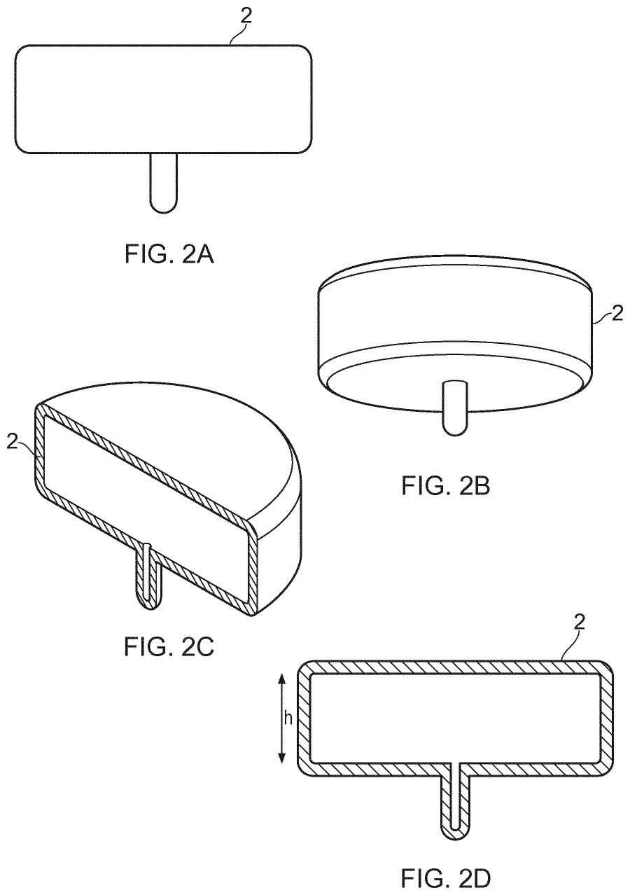

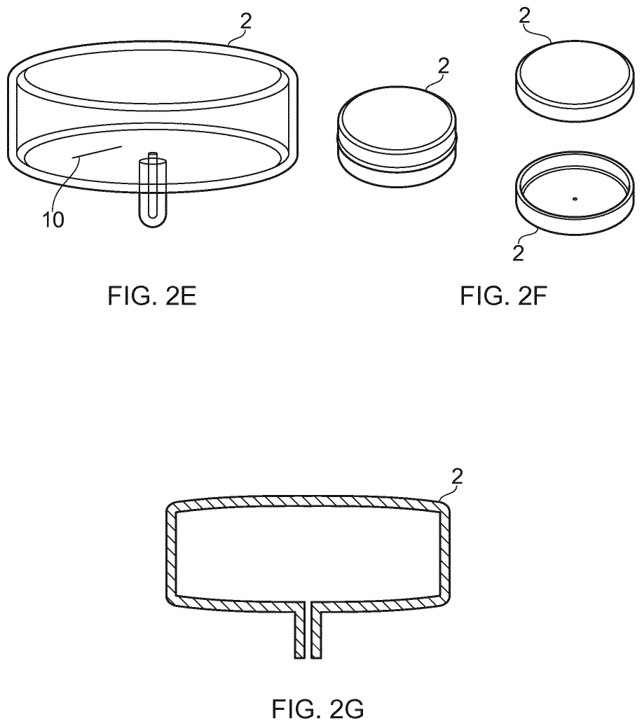

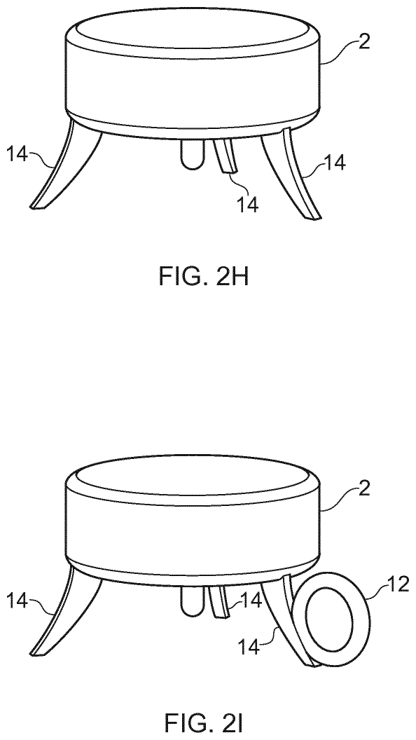

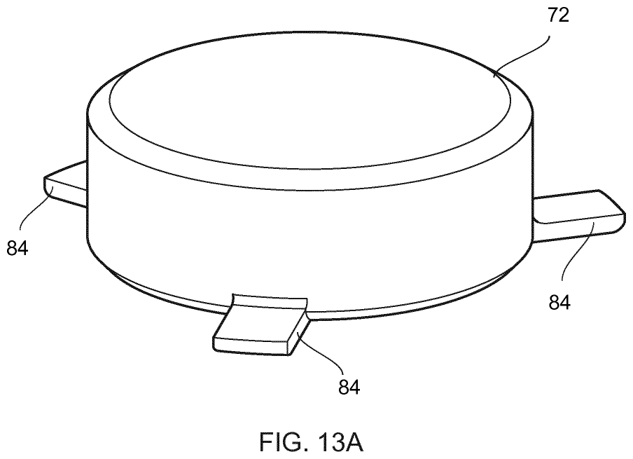

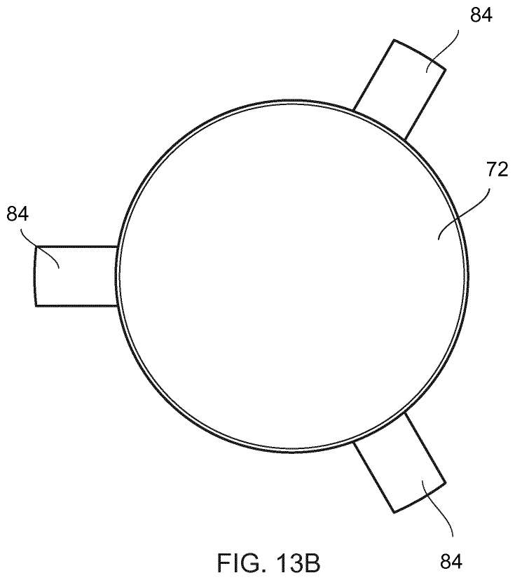

Examples of the cylinder are shown in FIGS. 2A to 21. They are made from a microwave transparent material, preferably evacuated to a pressure in the range of around 0.25 to 10 millibar. It is difficult to ignite the plasma at pressure below 0.25 millibar and at pressures above 10 millibar the plasma is non-uniform in extent. The flat ends of the cylinder are able to withstand external air pressure providing the thickness of the material used for its construction is sufficient to avoid cracking. While it depends on the size and shape of the low pressure gas chamber produced, the wall thickness is typically at least 3 mm.

The cylinder depth, gap or height h can be selected to provide appropriate heating power. Typically, an internal height h between the flat cylinder ends of at least 1.5 cm should be used for a cylinder of outer diameter 11.5 cm to create sufficient heat for frying.

When the metal frying plate 4 is placed atop the low pressure gas chamber 2, if the internal height of the glass cylinder is small, such as 1.5 cm, then it becomes more difficult to ignite plasma. Increasing the internal height to 3 cm results in more reliable plasma ignition at a microwave power achievable in conventional microwaves. This may be because the electric field intensity close to a metallic object is reduced to a low value and the energy is converted instead into strong electrical currents that flow in the surface of the conductive object (the well-known skin effect at high frequencies). With microwave oven Magnetrons operating at 2450 MHz, an internal height of 3 cm is close to one quarter of a wavelength (λ=12.24 cm) facilitating a higher field strength at this distance from the metal frying plate 4 so the plasma can ignite. Thus a low pressure gas chamber of external diameter of 10 cm and internal height of 3 cm is capable of igniting the plasma and produces sufficient heat to heat an overhanging circular metal frying plate 4 placed directly in contact with the low pressure gas chamber to fry a burger when sufficient microwave power is used.

The low pressure gas chamber 2 may be created as a non-circular shape such as a rectangle and may be most conveniently formed by first molding the shape and then fusing an additional flat plate to form the whole part. Alternatively, two identical cup shaped molded halves may be fused together as shown in FIG. 2F. A small molded-in pipe on one half, for example the lower half, facilitates the evacuation of air to the required pressure and finally sealing off with a gas flame. The manufacturing process is similar to that used for a glass vacuum flask. To increase energy efficiency, the upper half of the low pressure gas chamber 2 may be constructed of a heat absorbing glass and preferably the thermal expansion coefficient of the upper half matches that of the lower half to which it is to be fused during manufacture.

For a cylindrical low pressure gas chamber of outer diameter 10 cm and internal height of 3 cm it is to be recognized that when made from borosilicate glass, the wall thickness may be at least 0.3 cm to provide strength to resist external air pressure and avoid mechanical failure. This also applies to any short pipe used for evacuation and sealing off. Low pressure gas chambers run at microwave powers higher than 750W may require thicker walled glass in their construction.

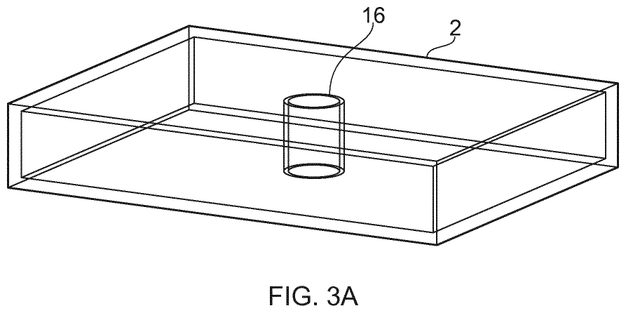

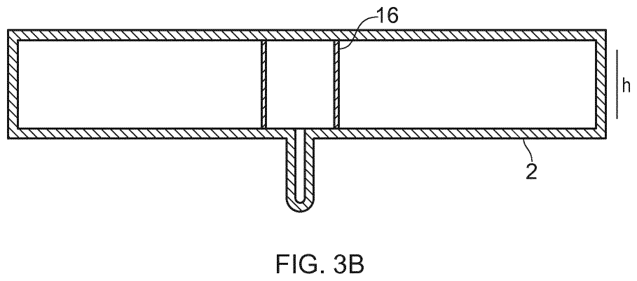

The tendency for external air pressure to collapse the so formed cavity can in principle be resisted by the integration of small diameter molded pillar spacers inside the low pressure gas chamber 2. This may be necessary for the creation of fryer plates 4 of larger surface area than would be needed for frying a single burger. However, these molded pillars may become too hot in the plasma environment and melt. Consequently, inserts made from a high melting point glass material may be required. Fused silica tubes 16, such as the one shown in FIGS. 3A and 3B, capable of withstanding much higher temperatures, are readily available in many diameters and when cut to length can easily function as support spacers for large diameter low pressure gas chambers. Typically they would be free-standing and be located in molded recesses to hold them in place.

It is to be recognized that molding the cylindrical low pressure gas chamber 2 with ends that are very slightly curved outwards will enable the walls to resist external air pressure rather better. When evacuated, the ends will be compressed towards being planar and greatly reduce any tendency to create tensile stresses on the inside of the chamber. The amount of curvature required will depend upon the chamber size and wall thickness used. In this way, the use of internal pillars or tubes 16 may be avoided.

Most conveniently, the cylinder is made from glass which can be molded to the required shape. The glass should be made from a composition able to withstand the heat of the plasma and possess a low coefficient of expansion to avoid fracture by thermal shock. Fused silica may be used for this purpose, having excellent thermal shock resistance on account of its mechanical strength and very low thermal expansivity (α=0.5×10⁻⁶ K⁻¹). Molding of fused silica is possible but usually reserved for high value technical or scientific products on account of the expense involved. The translucent grade known commercially as Vycor® (96% pure silica glass, softening point 1530° C.) enables molded articles to be produced more readily than pure fused silica by initially using a special two-phase glass composition but is expensive on account of the multi-step chemical (acid etching of the soluble phase) and thermal processing (1200° C. for consolidation of the pores formed by the heat treatment) route that is used to create the final article. Aluminosilicate glasses can be used for the low pressure gas chamber 2 as they have a much higher softening point (935-1005° C. depending on grade) than soda-lime glasses while still far less than that of silica but still have a relatively large coefficient of expansion (α=4.6×10⁻⁶ K⁻¹). As a compromise in terms of properties and processing cost, a preferred choice of glass are Borosilicate glasses as already used for many cookware items (viz. Pyrex®) and also for laboratory glassware. These hard glasses have a typical softening points in the range of 668° C. to 821° C. and low thermal expansivities in the range of 5.7×10⁻⁶ to 3.3×10⁻⁶ K⁻¹.

An alternative range of materials for the manufacture of the low pressure gas chamber 2 are glass ceramics. Being crystalline (after heat treatment of the molded article) they are not subject to progressive softening with increased temperature and are thus ideal materials for operation at higher microwave powers where temperatures may be reached whereby a glass capsule may collapse under the external air pressure. Such glass ceramic materials have already been employed for many years as cooker pan hobs on account of their high thermal shock resistance. One factor to be considered is the dielectric loss factor at microwave frequencies which should to be low enough to avoid energy absorption and subsequent self-heating by the glass or glass-ceramic itself. It is known that some ceramic materials exhibit thermal runaway under sufficiently high microwave excitation. One grade of glass-ceramics has a critical temperature of about 180° C. (at 9.37 GHz) above which thermal runaway occurs. Low-loss grades of borosilicate glass are available but at the expense of a somewhat higher thermal expansivity (4.9×10⁻⁶ K⁻¹).

While ordinary air is most convenient to use as the plasma medium, pure nitrogen or oxygen (the major components of air anyway) could be used. Pumping pure oxygen down to the low pressures needed here requires special oil-free pumps and has no advantage over nitrogen. In terms of electrical breakdown, nitrogen is about 15% higher than that of air and is likely to give a somewhat hotter plasma.

Argon will also perform although the heating effect is less than when air is used as it is a less electronegative gas than either nitrogen or oxygen. Its electrical breakdown strength is about 20% of that of air. Mixtures of air (or nitrogen) and argon can be used that vary the heating effect for a given input microwave power. In this way, one chamber design (i.e. size and shape) can be optimized for a given microwave oven power for a required temperature. For example, a chamber that only uses air as the plasma medium may be hot enough for a 750W microwave oven but become too hot for one that uses 1000W and so the same chamber design would use a mixture of air and argon to run at the same temperature as the small, less powerful, oven. In this way, two product versions can be offered optimized for different oven powers.

The gas used inside the low pressure gas chamber 2 may be simply air or other gases. Pure nitrogen has the advantage of being cheaper to use than the alternative gas argon. However, argon creates less heat and may be used to advantage when a more powerful oven might cause overheating to occur to the point where the glass become softened. Thus mixtures of nitrogen and argon can be used to adjust the heating ability of the plasma without having to alter the pressure away from the optimum point where uniformity of the plasma and easy ignition occur.

FIG. 2 shows various images (A-E) the low pressure gas chamber 2 after completion and also how a production method may be implemented by molding two separate halves which then are fused together in F. A low pressure gas chamber 2 with very slightly convex ends (shown here with exaggerated curvature) is shown in G. To test, the low pressure gas chamber 2 can be placed in a standard microwave oven, preferably raised off and away from the turntable using a Pyrex® glass support dish such as a Ramekin dish or similar. The exact position of the low pressure gas chamber within a given oven cavity for maximum heating effect may be found by trial and error but in practice this is not found to be critical.

FIGS. 2H and 21 show a more sophisticated design incorporating integrally molded legs 14 and also with a finger ring 12 to facilitate ease of handling.

For larger low pressure gas chambers, one or more internal support tubes 16, made from one or more short sections of fused silica tubing sitting in molded depressions on the lower half of the low pressure gas chamber 2, can be included and act as supports for the upper glass wall as shown in FIGS. 3A and 3B. This has the advantage of permitting a thinner upper wall of the chamber 2 without fear of cracking under external air pressure. The support tube 16 has a small notch at one end to facilitate easy extraction of air during pump-out prior to sealing off.

It is also to be recognized that the low pressure gas chamber 2 may not by itself readily facilitate the ignition of a plasma unless the applied microwave power is very high. There is an optimum pressure at which plasma ignition occurs most easily and depends upon factors such as the gas used and chamber geometry. Typically this tends to be around 1 millibar pressure with ordinary air as the plasma medium. However, in a closed chamber such as what we have here, the pressure will rise after ignition due to the heating effect. The pressure therefore may need to be set somewhat lower such that it can rise to a level where adequate heating is available.

The insertion of a metal wire 10 as shown in FIG. 2E inside the low pressure gas chamber 2 greatly facilitates ignition of the plasma. The wire 10 can simply lie on the internal floor of the glass chamber. The length of the wire 10 is most conveniently a quarter wavelength long where one end can rise at some point to a high voltage to strike the plasma. For the usual microwave oven with magnetron frequencies of 2450 MHz (λ=12.24 cm) the wire length of −3 cm is ideal although in practice longer and shorter lengths will still work. Experimentally, it has been found that even a small fragment of metal loaded within the chamber can facilitate plasma ignition although this is not optimum.

The material which the igniter wire 10 is made from is important. A stainless steel wire is a bad choice as experiments show that it absorbs microwave energy (like the cover 6 and fryer plate 4 would if made from stainless steel) and becomes extremely hot, glowing bright orange, indicating temperatures in excess of 800° C. This may cause damage to the glass surface and, given that the internal flat end surfaces or the glass chamber are in tension from the compressive effects of external air pressure, may result in cracking of the glass chamber at which point it admits air to the point where the plasma can no longer be excited.

A much better choice is a metal with high electrical conductivity such as silver which still has a high enough melting point to tolerate contact with the hot plasma and does not oxidise in air plasmas. In practice, silver plated copper wire is cheaper to use. Gold plating has, unlike silver, the advantage of also not being wetted by glass when in the soft or molten state. Carbon fibres can be used to facilitate plasma ignition and do not react with glass when hot (glass does not wet carbon). Preferably, if Carbon fibres are used, an inert gas such as argon is used to fill the chamber to avoid oxidation or nitridation of the carbon fibre.

The igniter wire 10 may be conformal with the surface of the glass to avoid being heated by the plasma. For a low pressure gas chamber 2 that has flat ends, this means that the igniter wire 10 may be coplanar with the flat ends and most conveniently straight. It is observed that there is a so-called ‘plasma sheath’ next to the glass surface where no visible light emission occurs. The igniter wire 10 lies within this region and remains cooler than it would be if allowed to be positioned within the plasma itself. It has been observed that thin platinum wire, melting point 1840° C., can be melted by exposure to the plasma.

The igniter wire 10 can become bonded to the internal surface of the glass chamber as the plasma temperature is hot enough to soften the inner surface of the chamber and the weight of the wire 10 will allow it to partly embed in the wall. An alternative method of embedding the igniter wire 10 into the sides or base of the glass plasma chamber requires a wire alloy with a coefficient of expansion close to the glass is required. This requirement is usually met for borosilicate glasses by using the well-known FeNiCo alloy Kovar™ or other metals such as Molybdenum and Tungsten, depending upon the grade of glass that is to be used. Only the very ends of the wire 10 needs to be exposed to the gas to facilitate plasma ignition.

An internal metal igniter may be rolled into a wider strip to spread its weight over a larger area and lessen the tendency to sink into the softened glass surface when the plasma is heating it. A metal strip some several millimeters wide would be preferable to a round wire in this case. To avoid wetting of the wire or strip by the softened glass, a gold plating can be used on the wire or strip to prevent this.

In keeping with the observation that even small metal fragments can facilitate plasma ignition, such fragments may preferably be flattened into disc shapes to avoid sinking into the softened glass of the low pressure gas chamber.

An alternative method of striking the plasma into ignition is to employ a small amount of radioactive material inside the low pressure gas chamber 2. Such materials provide a source of ionizing radiation which facilitate the creation of a plasma. A low level emitter such as Thorium oxide (Thoria, ThO₂) can be introduced in the form of a small amount of powder or even painted onto the internal glass surface. Other emitters may be mixed with the gas itself such as Krypton-28. However, experiments shows that the use of a metal wire igniter is more reliable, cheaper and far more acceptable in terms of environmental safety.

The preferred embodiment for increasing the electric field strength in the vicinity of the glass chamber is to position it between two metal surfaces spaced an integral number of half-wavelengths apart. In this way, a localized standing wave pattern is set up inside the multi-mode oven cavity. The metal surfaces act as a resonator in the same manner as the mirrors of a laser do. While this could be done by using two metal strips (length λ/2 ˜6 cm) on either side of the chamber, a more convenient and simpler method is to use a single second circular metal plate 26 (minimum diameter λ/2 ˜6 cm for effective operation) positioned directly below the glass chamber and spaced electrically one-half wavelength away from and plane parallel to, the underside of the fryer plate 4, a resonator structure may also be constructed. This resonator performs better if the reflector plate 26 is a minimum of one half wavelength in diameter (6.12 cm at 2450 MHz). Experiments show that reflector plates 26 of diameter 6 cm and 12 cm both work well in practice as do diameters between 6 cm and 12 cm. The reflector plate may also be of a non-circular shape. Once again the choice of material should be one of high electrical conductivity such as aluminium on the grounds of lowest cost and performance. This reflector plate 26 can either be a rigid flat metal plate held by its edges or a thin foil bonded to, or embedded within, a supporting dielectric material of low microwave loss.

The reflector disk or plate 26 can be held in place by a base unit 28 which itself is clipped to the bottom of a shroud 36, 44 used to hold the fryer plate 4 to the low pressure gas chamber 2.

The resonator method has the great advantage of avoiding damage to the glass as discussed above as no internal metal igniter wire 10 is required at all.

It is to be recognized that such a reflector plate 26, forming part of the resonator structure, may require a hole in it to facilitate incorporation of the seal off nipple used for chamber evacuation depending upon the length of the nipple.

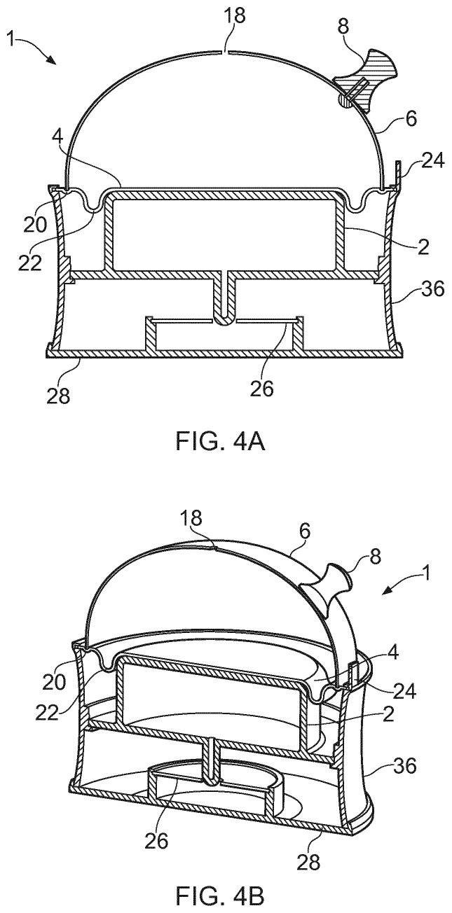

The incorporation of a resonator structure that creates a more intense electric field intensity by means of the addition of a flat reflector plate 26 spaced electrically an integral number of half wavelengths away from the bottom side of the fryer plate 4 is shown in FIG. 4 (A&B). A 3D cross-section in B shows that the reflector plate 26 is held in place by a molded base unit 28 which itself is clipped onto the molded-rubber shroud 36. The reflector plate 26 shown here has a hole to allow space for the seal-off nipple of the low pressure gas chamber 2. This hole may not be necessary if a sufficiently short seal-off nipple can be formed or the nipple is formed on another surface of the low pressure gas chamber 2. In this drawing the reflector plate 26 here has been sized to be one half-wavelength in diameter although in practice larger diameter discs will function well and will also reflect more of the emitted infrared radiation.

Ideally, the distance between the fryer plate and the reflector plate containing the low pressure gas chamber is electrically close to half a wavelength of the microwave radiation. So, the actual physical distance depends upon the type and amount of different materials present between the plates and also the frequency used (currently 2450 MHz in domestic ovens). In general, thicker glass walls of the low pressure gas chamber mean a smaller total air gap is needed. For example, if the total glass thickness (two parallel walls each 0.33 cm thick) is 0.66 cm then the ideal air gap total would be 5.41 cm making the spacing between the metal plates 6.07 cm. This assumes a dielectric constant for the glass of ε=4.6, typical of borosilicate glass. Even with a wall thickness of 0.65 mm the total reflector spacing is 6.026 cm. The ideal gap between the plates drops slowly as the glass thickness increases.

For non-circular designs, a non-circular reflector plate 26 may be more appropriate.

In order for plasma to be excited in the low pressure gas chamber 2, the electric field intensity inside the oven cavity has to become large enough to cause ionization of the low pressure gas inside the chamber. The electric field intensity in the low pressure gas chamber 2 is reduced in the presence of a microwave absorber such as food. So to reduce the microwave power needed to allow plasma to be formed in the low pressure gas chamber 2, the item to be fried can be shielded from microwaves by placing it inside a metal container such as a metal frying plate 4 topped with a matching close fitting cover 6 which is then placed on the low pressure gas chamber 2. Provided that the metal container does not possess sharp corners, it is found that, with oven cavities of sufficient size, there is no arcing caused by the presence of metal.

For the purposes of frying a burger where fat and water needs to be drained off, it is possible to construct a metal fryer/cooker plate 4 lying in direct intimate thermal contact with the plasma chamber, which has a deep circular trench 22 stamped around it to accept fat draining off. A domed cylindrical cover 6 covers both the burger and the fat drain trench 22 to avoid any absorption of microwave energy. The edge of the cover 6 sits in a narrow groove 20 close to the periphery of the fryer plate 4 to secure its position. The frying plate 4 overhangs the cylindrical plasma chamber 2.

The domed cover 6 can be fitted with a small knob 8 to ease lifting and the placement of the knob may be more advantageous if it is situated offset such that the cover 6 can be lifted more easily in the restricted space of the microwave oven cavity. The material used to make the knob 8 should not appreciably absorb microwave energy otherwise it too will become hot; fluorinated materials such as Teflon® AF, ETFE, PTFE, PFA, FEP and molded silicone rubber have high operating temperatures and low microwave frequency dissipation factors. The lifting knob 8 can be attached to the domed cover 6 by an integral molded barb, pushed through a suitably sized hole in the cover 6 or by means of a screw. In the case of the screw method, the screw material should ideally be made from a highly conductive material such as aluminium to prevent the high surface currents from causing heating of the knob 8 from the inside making it hard to handle after use.

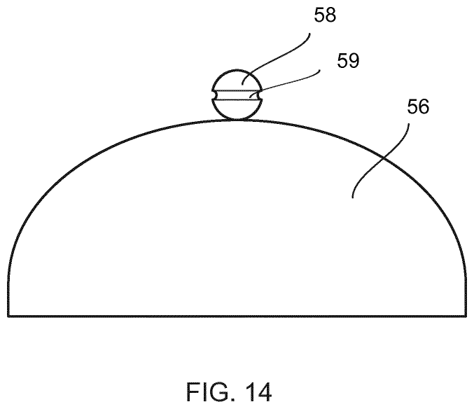

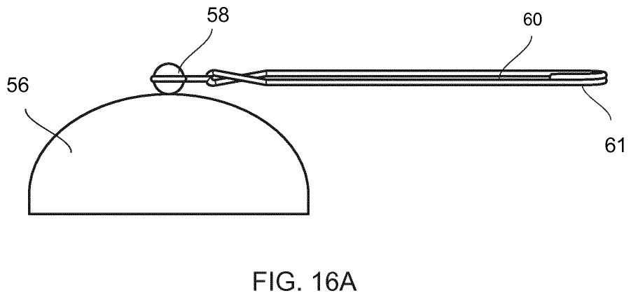

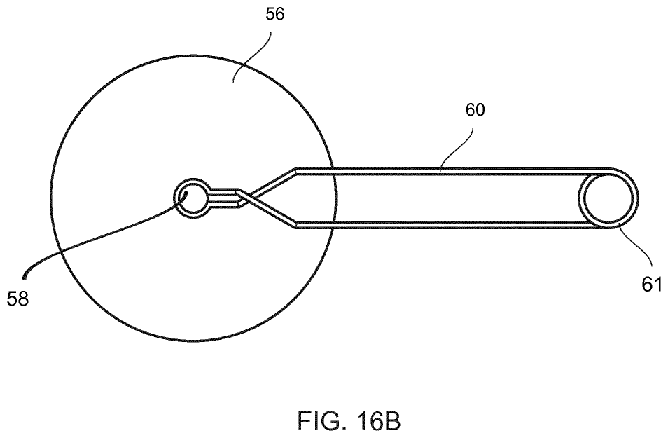

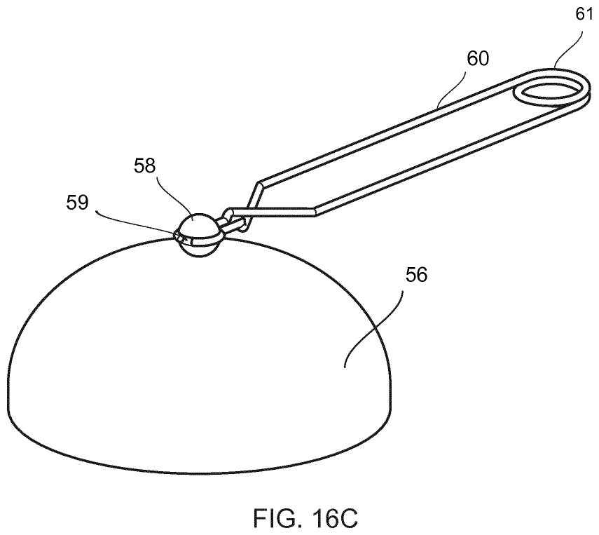

An alternative metal cover 56 is shown in FIGS. 14 and 16A to 16C. The metal cover 56 is the same as the metal cover 6 described above, except metal cover 56 does not have an offset knob 8. Instead, metal cover 56 has a central knob 58 on the top of the metal cover 56 which can be gripped by tongs. Whilst it is advantageous to locate the knob 58 in the centre of the metal cover so that it can be reached whatever the orientation of the cover in a microwave oven, in other embodiments, the knob 58 could be positioned offset from the centre of the metal cover 56.

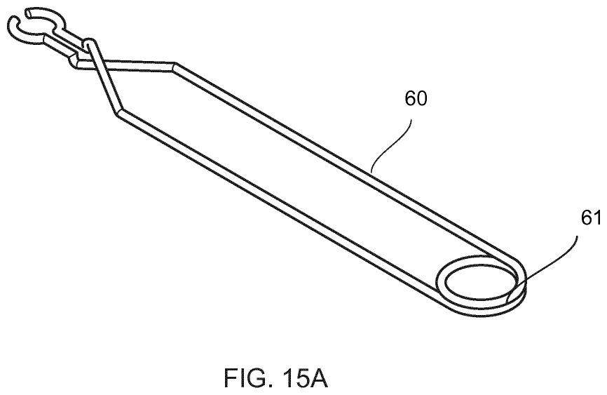

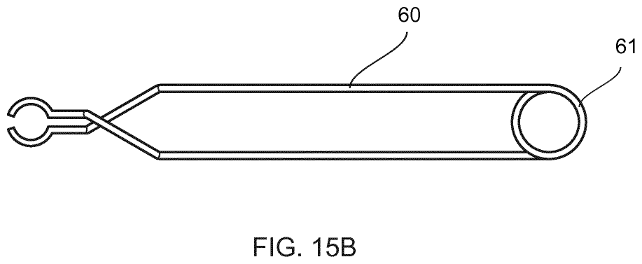

The central knob 58 is a round shape with a circular groove 59 around its equator which enables the use of self-gripping tongs. Such tongs can engage the groove 59 to provide a more secure method of holding the metal cover 56, which may be hot, away from the rest of the cooking device when food is being turned over for further frying. FIGS. 15A and 15B show self-gripping tongs 60 and FIGS. 16A-C show the self-gripping tongs 60 engaging with the groove 59 to grip the knob 58. A short coiled section 61 at the rear of the tongs facilitates less force for actuation by hand than is exerted on the knob 58. The tongs 60 may be fabricated out of a length of thick wire; the diameter of the wire is around 3 mm and matches the profile of the groove 59 in the knob 58.

The domed cover 6 may be provided with a small hole/vent 18 or a plurality of small holes near the top of the cover to facilitate the escape of water vapour; the diameter of the hole(s) should be much less than the wavelength of the microwaves. Holes 18 of diameter in the range 1-2 mm are sufficient. A domed cover 6 is superior to a flat topped cylindrical one in that it scatters the microwaves better inside the oven cavity and does not offer a microwave ‘trap’ between the flat roof of the cavity and the flat top of the cover 6. The plasma is more likely to ignite with a domed cover 6 than a flat topped one.

It will be found that the choice of material for the fryer plate 4 and the domed cover 6 needs to be taken into consideration. The usual choice of stainless steel for metal cookware, on grounds of durability, is compromised by the fact that stainless steel has poor electrical conductivity. High circulating currents occur on the surface of the metal inside a microwave oven and this results in absorption of microwave energy thus robbing the plasma chamber of power making it more difficult to strike the plasma into ignition. Also, the poor thermal conductivity of stainless steel can result in localized hot-spots which may create surface oxidation of the metal by overheating. A better choice of material for this application is aluminium or one of its alloys which despite being mechanically weaker than stainless steel, have much better electrical and thermal conductivity. Alternatively the stainless item can be electroplated with a high conductivity material such as silver or vacuum/spray coat with aluminium. Aluminium covers also have the advantage of a lighter weight.

The interface between the domed cover 6 and the fryer plate 4 benefits from the application of an electrically insulating non-stick coating to prevent arcing at points within the narrow groove 20 in which the edge of the cover 6 sits. High circulating currents on the surface of the metal exist and localized arcing or micro-discharges can erode away the metal. Such arcing only occurs prior to plasma ignition and is a source of energy dissipation that must be avoided to ensure ignition of the low pressure gas into a plasma state. Consequently, the groove 20 should be deep enough to accommodate a sufficiently thick layer of insulating material. These non-stick coatings are best made from a fluorinated polymer such as PTFE or similar which have adequate dielectric strength and low dielectric loss.

The best design for frying a burger has a flat surface which enables the burger to be slid off using a kitchen frying slice tool. However, it is to be recognized that there is an advantage in having a slight curvature to the metal plate to facilitate this draining and thus that a matching slight curvature in the top glass fryer surface is advantageous. This advantage is in addition to the extra resistance to cracking provided by curved ends when evacuated.

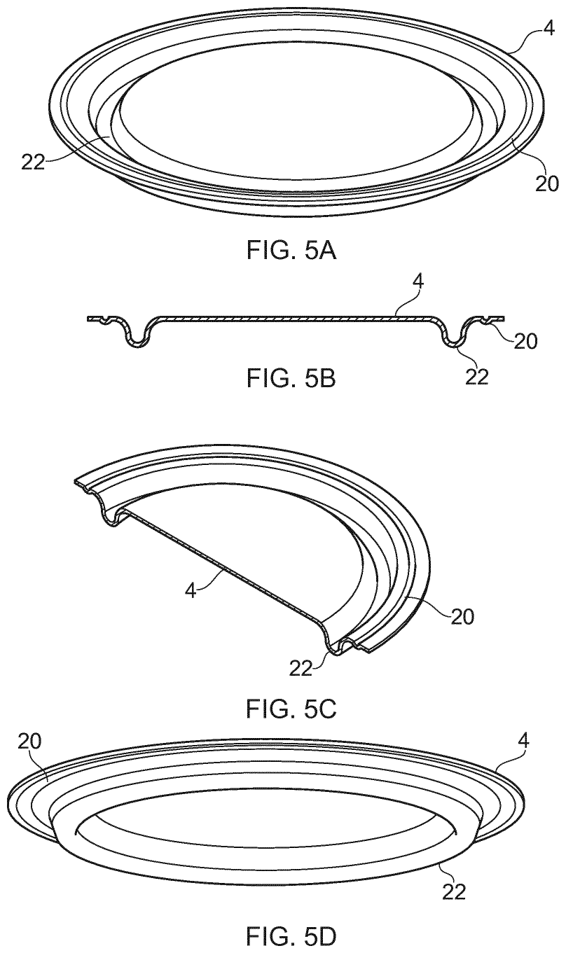

FIG. 5 shows the fryer plate 4 for burgers and two concentric circular impressions can be seen in A with cross-section in B and in 3D view, C. The underside of the fryer plate 4 is shown in D. The deepest part, at some 8 mm deep, is the fat drain trench 22 with a 14 mL capacity; a typical burger will exude at least 5 mL of fat and water. The narrow outer impression is only 1 mm deep by 2 mm wide and serves to locate the matching cover 6 which is used to cover the burger on the fryer plate 4.

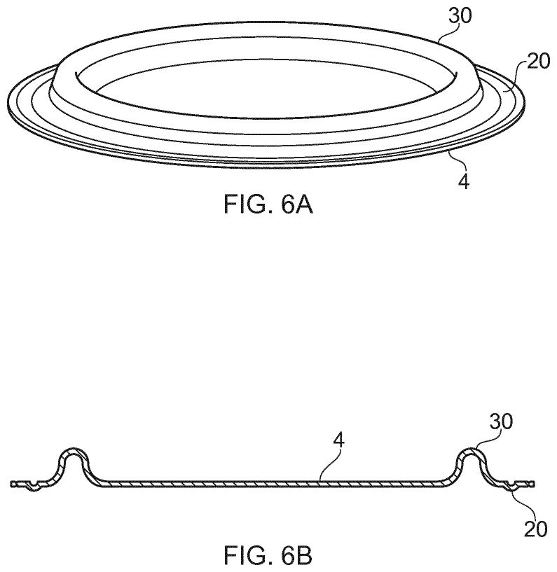

FIG. 6 shows the fryer plate 4 for eggs in A and its cross-section in B. The main difference here is the raised barrier 30 to prevent spillage of the uncooked egg out towards the join between the cover 6 and the fryer plate 4.

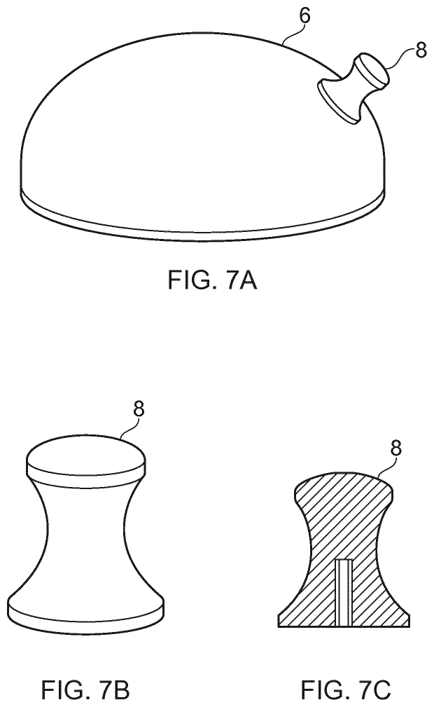

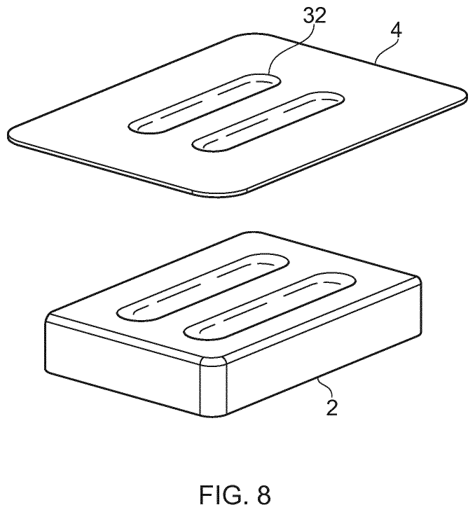

FIG. 7 shows the substantially hemispherical cover 6 in A with offset plastic or rubber knob 8. The knob shape is further shown in 7B and 7C and is designed to shield the user's fingers from contact with the hot cover 6 by flaring out near the base of the knob 8 and also simultaneously providing enough positive grip between two fingers and a thumb. A section of the knob 8 in C shows the screw hole on the base. The screw should ideally be made from a high electrically conductivity material such as aluminium and not stainless steel.

Both fryer/cooker plate and cover 6 may be coated with a non-stick layer such as a PTFE containing material.

With the above basic simple set-up as shown in FIG. 1 and using a simple glass support for the low pressure gas chamber 2 (not shown in FIG. 6), a 900W oven run at 600W setting (Panasonic® flatbed design with inverter power control) will brown the burger on one side within four minutes at full power. The burger may then be turned over to brown the other side.

A detachable design of fryer/cooker plate facilitates the creation of a second simple pan and cover 6 assembly which can be used for the frying of and egg where a fat drain 22 is not required but substantial walls 30 are needed to prevent the egg from running over the edge.

The metal frying plate 4 can be shaped to better cook certain specific foods. An example of a food-specific metal frying plate 4 is shown in FIG. 8. The frying plate 4 can be modified to have linear or curved grooves or sunken portions 32 of substantially circular cross-section (half circle ideally) in the top fryer plate 4 which can accept the placement of sausages. The cross-sectional curvature of the sunken portions 32 can be made to match to the radius of curvature of the sausages such that a more intimate contact is made. In this way, providing the grooves 32 are sufficiently deep, a more even cooking of the sausage is obtained and facilitates the need to only turn the sausage over once to obtain a fully cooked item of food. The diameter of the semi-circular cross section grooves 32 can match the diameter of an average sausage and/or several grooves 32 of differing diameter can be formed into the unit to accept more than one size of sausage. The necessary matching metal cover 6 is not shown in FIG. 8.

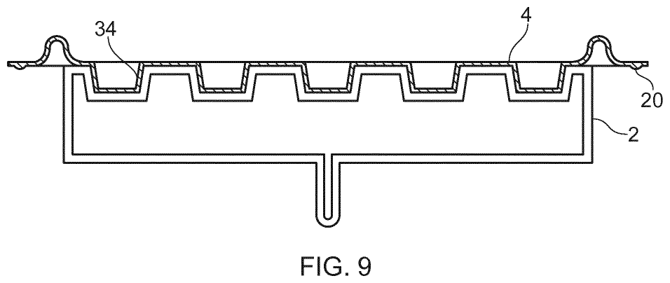

The metal frying plate design can be extended to a coarse deeply textured form 34 which facilitates the production of waffles from a batter mixture. A low pressure gas chamber of matching form can be provided to gain intimate thermal contact with the metal frying plate 4 and facilitate better heat transfer to the batter. A design which shows how waffles can be cooked by molding a deep pattern onto the upper surface of the low pressure gas chamber/cooker plate is seen cross-sectioned in FIG. 9. The sides of the depressions in the pattern 34 are tapered slightly to facilitate ease of extraction of the cooked waffle.

Other additional features can be provided to improve efficiency in transferring heat to food on the metal frying plate 4 by directing infrared radiation towards the metal frying plate 4. The low pressure gas chamber 2 may sit on top of a fibrous insulation layer to trap and reflect infrared radiation as heating towards the food. The insulation should be of a type that does not appreciably absorb microwave energy (or exhibit a tendency for thermal runaway). However, in practice a simple glass support for the chamber will suffice and may take the form of three legs 14 molded to the sides of the chamber raising it off the turntable of the oven to avoid overheating of the latter which may be made of plastic.

An alternative way to reflect infrared radiation back into the low pressure gas chamber 2 is to employ a broadband purely dielectric coating. Only the base or sides of the chamber need to be coated. Those skilled in the art of creating such coatings (usually multilayer) will know how to implement such enhancements. Infra-red reflecting materials such as Indium-Tin Oxides are metallic in nature and will reflect or absorb the microwaves and cannot be used for this application.

The embodiment of using a reflector plate 26 as employed in the resonator to increase the electric field strength in the chamber will naturally have the advantage of also reflecting at least some of the infrared radiation emitted by the low pressure gas chamber 2; larger reflector plates therefore have an advantage of reflecting more of this heat which would otherwise be lost. A gold or titanium nitride coating on the reflector plate 26 would increase the level of infrared reflectivity even further; gold being preferable in terms of its higher electrical conductivity than titanium nitride.

One way to capture the additional radiant infrared energy is to interpose a thin free standing disc of heat absorbing glass in intimate contact between both the fryer plate 4 and the low pressure gas chamber 2. This has the advantage of avoiding constraints of dissimilar thermal expansivities as there is no bond at the interfaces. The extra glass thickness and additional interface does however reduce thermal conduction to the fryer plate 4.

The thermal resistance of the interface between the low pressure gas chamber 2 and the fryer plate 4 can be reduced by the use of a thermally stable fluid or grease. Such materials are readily available but make cleaning of the fryer plate 4 after use potentially more difficult depending upon the overall design.

An alternative to improving thermal efficiency of the fryer/cooker plate component is to produce a fryer plate 4 which has high emissivity. Natural aluminium or stainless are highly reflective and have low emissivities. Aluminium can be anodized and this provides a useful mechanical key for the application of a dark non-stick coating such as that invariably employed on standard frying pans. Such coatings are dark in appearance and thus have high emissivities and absorb heat better and are of course much easier to clean after use.

Depending upon the oven design and level of sophistication, there may be a non-uniform distribution of electromagnetic energy within the oven cavity space, and subsequently an optimum position for the plasma chamber to operate correctly which can be found by trial and error. This is particularly the case with ovens with small cavities as the density of electromagnetic modes is less leading to an emphasis on hot and cold spots. Placement of the assembled unit on the usual oven turntable facilitates movements of the plasma chamber through the inevitable hot and cold spots of the oven cavities microwave field distribution and enables uniform heating by time integrated changes in the plasma discharge within the low pressure gas chamber 2.

For reasons of safety, there is advantage in encapsulation the low pressure gas chamber 2 with a high temperature polymer film such as FEP (Fluoro ethylene propylene polymer) or other similar grade of fluorinated polymer which acts as a containment for glass fragments should the low pressure gas chamber 2 become broken accidentally. Such films may be most conveniently applied from dipping in commercially available amorphous fluoropolymer solutions.

As an alternative, a molded fluoropolymer or silicone rubber shroud 36 may be formed which also acts as a mechanical assembly or clamp to hold the low pressure gas chamber 2 to the fryer/cooker plate and also the reflector plate 26 in the correct position. Silicone rubber is cheaper than FEP and can now be injection molded and cured in-situ within the mold making it an ideal material for holding and protecting the low pressure gas chamber 2 and also holding the fryer plate 4 in direct thermal contact to the low pressure gas chamber.

Alternatively, a molded glass assembly may be used together with a molded silicone rubber ring to join together the fryer plate 4 and the low pressure gas chamber 2. Both approaches are not limited to substantially circular shaped fryers and may be employed for rectangular or any other desired shape.

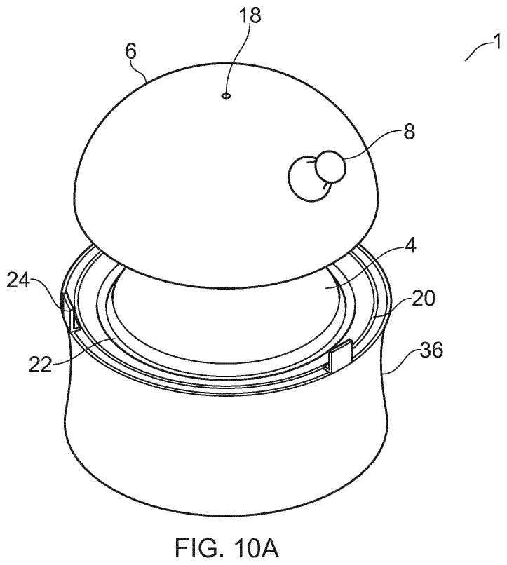

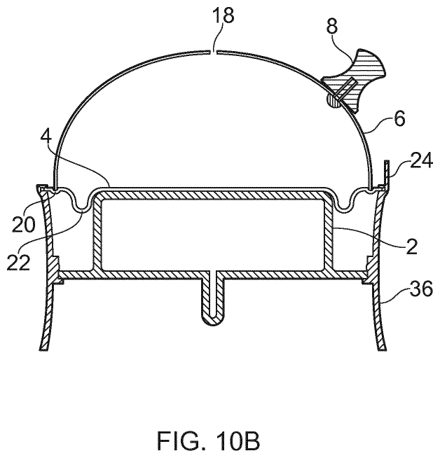

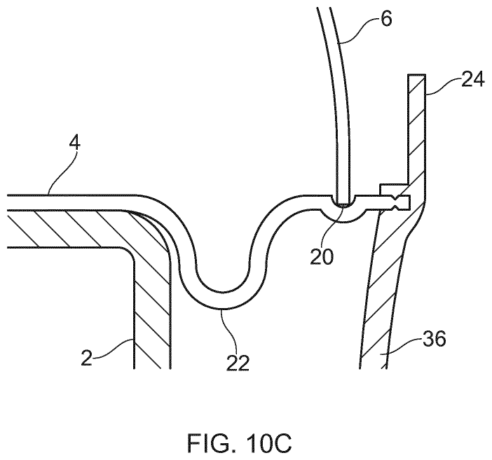

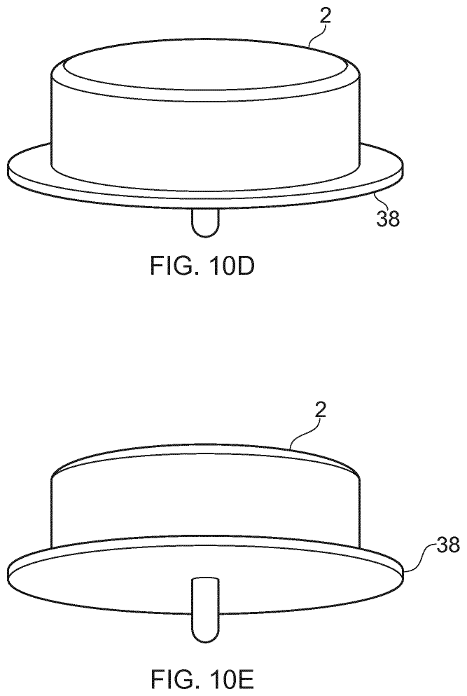

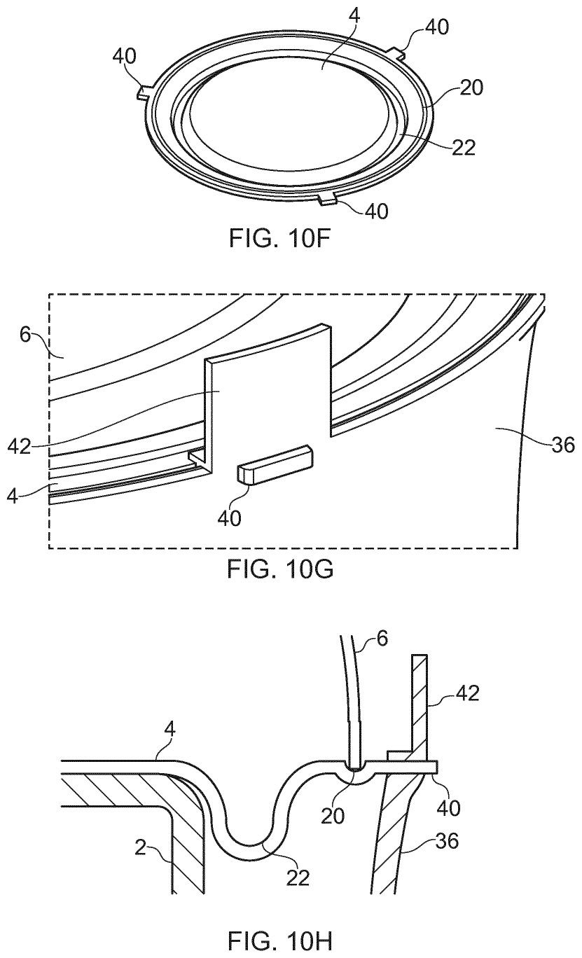

FIG. 10 shows (A-C) how the top fryer/cooker plate can be clamped to the low pressure gas chamber 2 by a circular high temperature polymer or rubber shroud 36 which has the benefit of providing protection for the low pressure gas chamber 2 against accidental damage and also facilitates the introduction of a convenient handle for insertion or extraction from the microwave oven cavity. The low pressure gas chamber 2 now has a molded flange 38 at its base (see FIGS. 10D and 10E) which facilitates being gripped in place by the shroud 36 as seen in cross-section. The shroud 36 has a plurality of molded in tabs 24, typically three, which grip the fryer plate 4 in place and hold it against the upper surface of the low pressure gas chamber 2. This enables the removal of the fryer plate 4 for cleaning or to change it to another one of different design and function. As an alternative embodiment, the fryer plate 4 can be made with three tabs 40 at the edge which fit into three slots molded into the rubber shroud 36 (F, G & H).

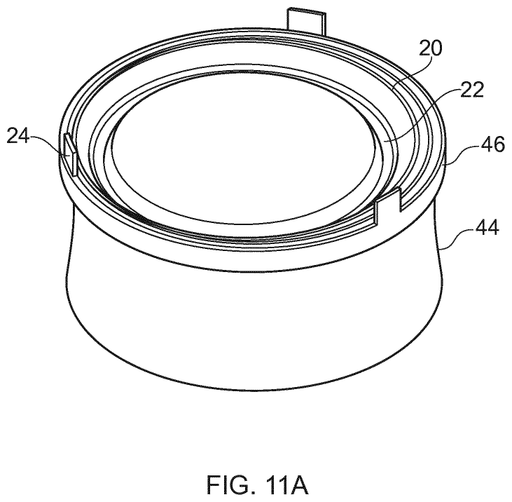

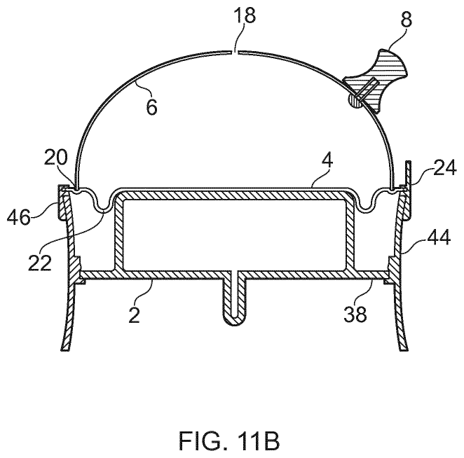

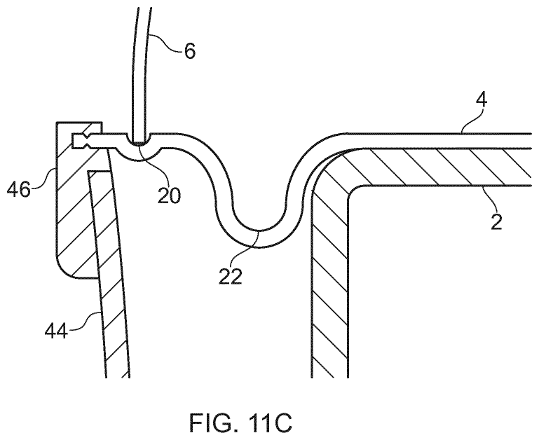

FIG. 11 (A, B & C) shows a variation of FIG. 10 whereby the shroud 44 is now made of molded glass and is connected to the fryer plate 4 by a molded rubber/silicone ring 46 which snaps over the glass shroud 44 and grips the edges of the fryer plate 4.

An optional Pyrex® glass cover can be used to retain heat generated by the plasma chamber and to prevent overheating of the oven cavity. It may be advantageous to use a close fitting outer cover, transparent to microwaves, trapping heat rising up from the entire fryer unit and reduced the heat loading inside the microwave oven cavity. The cover may usefully be constructed of borosilicate glass and may incorporate a single lifting handle on top or two lifting handles at opposite sides near its base.

An example of a manufacturing method for the low pressure gas chamber 2, in this case having a wire igniter 10, is to use glass blowing. A low pressure gas chamber 2 is formed by a skilled glass blower out of borosilicate glass with walls some 3.3 mm thick in the shape of a flat cylinder some 100 mm outer diameter and with an internal gap between the two end plates of 30 mm; the total external cylinder length is then 36.6 mm. It may be found advantageous to form the low pressure gas chamber 2 on a glass lathe by those skilled in the art of glass working. The outer radius of the edges will be of the order of 5 mm or less. A length of glass tubing of outside diameter 9 mm, bore 3 mm and length 60 mm is fused to one of the flat bases of the chamber making sure that at no point does the wall thickness fall below 3 mm at the join. A short straight length of silver or gold plated copper or Kovar™ wire, acting as an igniter, some 3 cm in length and of standard wire gauge in the range 20 to 30 is inserted into the chamber via the glass tube. This tube facilitates the attachment of a simple rotary vacuum pump using a flexible stainless steel hose assembly connected using a Cajon Ultra-Torr fitting attached to one end of a stainless steel flexible hose line. Alternatively, a very short length of highly flexible silicone rubber tube can be used as a bridge connection to the end of a 0.63 cm (¼″) stainless tube. The pressure in the chamber is measured using a digital gauge of the Pirani type and adjusted to a pressure in the range of 0.50 millibar to 10 millibar using a variable leak needle valve. Typically, a pressure of 1 mbar serves well although when using a wire igniter, plasma can be ignited over a wide range of pressures. When using the resonator method as a means of igniting the plasma, tests show that a pressure of 0.75 millibar is optimum as at this pressure, the plasma can be ignited using lower microwave powers more easily.

It will be found that, when using a resonator igniter and having no metallic wire present in the low pressure chamber, once the plasma has been struck for the first time at powers typically in the range 600W to 900W, subsequent plasma ignitions can be effected at much lower powers, even as low as 100W. This provides a very simple means of enabling much lower temperatures when using ovens equipped with inverter control where true power control is possible by first priming the unit for a few seconds at high power and then running separately at low power.

Once stabilized at the required pressure, the glass tube can be permanently sealed off near to the cylinder using a hot gas jet.

A circular fryer/cooker plate can be made, with a deep fat drain trench 22 and also a location groove 20 for the matching cover 6, by pressing aluminium sheet between two profiled steel dies. As a compromise between sufficient robustness in use and ease of pressing a gauge thickness of 1.5 mm can be used. To gain maximum thermal conductivity grade 1050 alloy can be used (99.5% Aluminium) which when properly annealed is very easy to press. For prototyping purposes, the grade of steel used for the two pressing dies can be EN1A which is case hardened as an alternative to the more expensive D2 tool steel that might be used for production work. In the event that a hydraulic press is not available, the required pressure can be produced by a ring of 18 bolts of M8 size. Greasing the threads and also the die faces will greatly facilitate reducing the torque required to tighten the bolts.

The microwave shielding cover 6 is of essentially hemispherical shape and is also made from grade 1050 aluminium alloy. The most suitable shaping method for small quantities is by metal spinning over a mandrel. Note that the spinning process tends to stretch the metal and results in a reduction of some 30% or so therefore a starting sheet thickness somewhat thicker may be advisable. Alternatively, for production where large numbers are to be made, the dome may be fabricated by a number of successive blanking steps using progressively deeper dies.

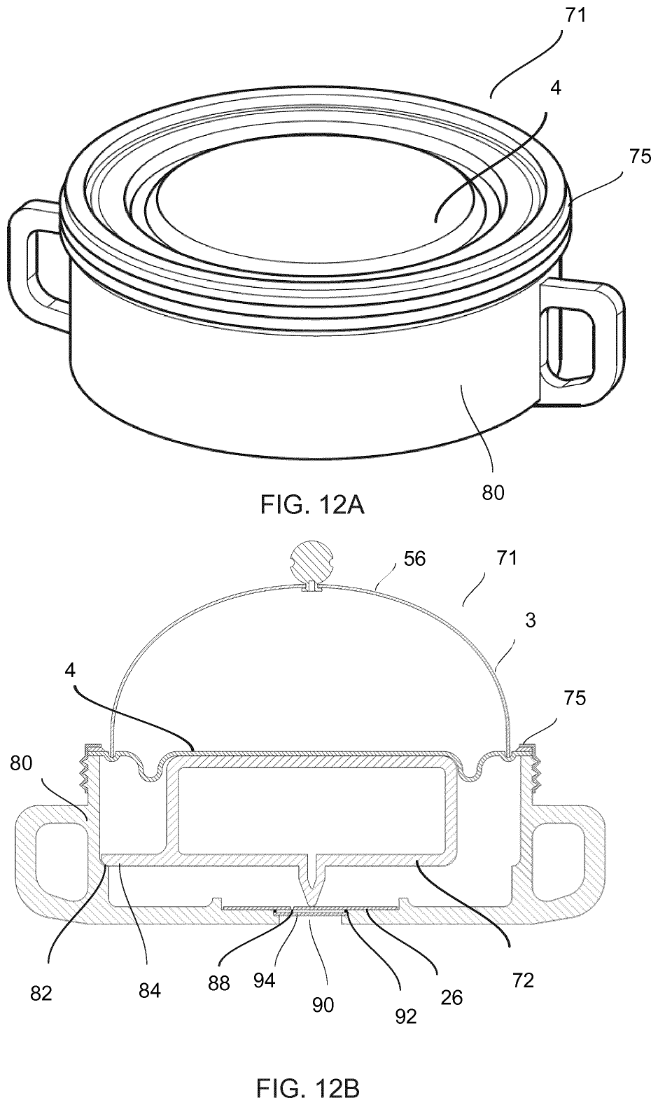

FIGS. 12A and 12B show an example of a cooking device 71 according to the present invention having a low pressure gas chamber 72, and a metal cooking enclosure 3 formed of a metal frying/fryer plate 4 and a metal cover 56.

In use, the metal frying plate 4 is secured to the low pressure gas chamber 72 by threaded clamp 75 so that heat produced in the low pressure gas chamber 72 is transferred by conduction to the metal frying plate 4 and food placed on the metal frying plate 4 can be cooked. The metal cover 56 is placed atop the metal frying plate 4 so as to shield food on the metal frying plate 4 from microwave radiation.

The safety shroud 80 is formed of glass and may be formed by molding. It also acts as a base for the cooking device. The safety shroud has three ledge portions 82 to support the low pressure gas chamber 72 via engagement of the ledge portions 82 with tabs 84 on the low pressure gas chamber 72. This arrangement enables air to escape from the device more easily during heating of the device. In other embodiments, this effect may also be achieved by molding the inside of the shroud 80 in such a way to allow air to escape even with a circular flange as shown in FIGS. 10D and 10E. Additionally, a circular flange on the plasma cell may incorporate a small cut-out to allow air to escape.

The center of the bottom of the safety shroud 80 holds a reflector plate 26. The reflector plate 26 may have a hole 88 through the plate which overlies a hole 90 in the base of the safety shroud to allow air to escape the device when the cooking device is heated. Allowing air to escape during heating reduces the risk of the increased pressure in the shroud causing the shroud or the low pressure gas chamber 72 to fracture.

However, it is not desirable to allow ingress of water during washing after use as this would make cleaning of the device more difficult. Further, any such water should be wiped away after disassembly of the unit or allowed to dry, otherwise microwave absorption by the water may hinder the process of striking the low pressure gas inside the low pressure gas chamber into the plasma state.

A method for permitting the free passage of air from the interior space of the safety shroud 80 while preventing ingress of water is to employ a microporous PTFE (Teflon®) plate or foil 94 over hole 90 that permits the expulsion of air from the interior as it become heated up by the plasma cell. Such materials are now available commercially. The PTFE is hydrophobic and does not allow ingress of wash water when the device is being cleaned after use. Such selective barriers are well-known for use in other applications such as car headlight housings. The PTFE foil or plate 94 is held in place by pressure transmitted by the reflector disc onto an O-ring seal 92 located between the two. This O-ring 92 also exposes the full area of the membrane to the air. Force is applied via the seal-off nipple on the plasma cell which has been levelled to the correct length during its formation. The hole 88 in the reflector plate 26 permits air to escape easily across the entire membrane area.

The safety shroud 80 has a threaded section at the top of its outer surface. The threaded clamp 75 is complementary to the threaded section so that to secure the frying plate 4 to the low pressure gas chamber 72, the plate is placed on the low pressure gas chamber and then threaded clamp 75 can be screwed onto the threaded section of the safety shroud 80 to hold the frying plate 4 in place. A circular rubber seal may also be used between the threaded clamp 75 and the frying plate 4 to hold the frying plate securely in place. The safety shroud 80 also has two finger handles molded at opposite sides to facilitate handling of the device. FIG. 12A shows the device with the domed lid removed.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention. For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A cooking device for frying food in a microwave oven, the cooking device comprising:
a low pressure gas chamber;
a plasma igniting means configured to ignite plasma within the low pressure gas chamber when supplied with microwave radiation; and
a cooking enclosure formed of metal, the cooking enclosure defining a food-receiving region and being thermally coupled to the low pressure gas chamber.

2. A cooking device according to claim 1, wherein the plasma igniting means is a microwave resonator proximal to or within the low pressure gas chamber.

3. A cooking device according to claim 2, wherein the microwave resonator comprises two metal reflector plates spaced apart from one another.

4. A cooking device according to claim 3, wherein the low pressure gas chamber is positioned between the two metal reflector plates.

5. A cooking device according to claim 2, wherein the microwave resonator comprises a metal wire and wherein the wire has a thermal expansivity matching a thermal expansivity of a wall of the low pressure gas chamber.

6. (canceled)

7. (canceled)

8. A cooking device according to claim 5, wherein the wire lies along an inner wall of the low pressure gas chamber or is embedded in a wall of the low pressure gas chamber.

9. A cooking device according to claim 1, wherein the cooking enclosure comprises a metal frying plate on top of the low pressure gas chamber and a metal cover locatable on the metal frying plate to enclose the food-receiving region.

10. A cooking device according to claim 9, wherein the metal frying plate forms one of the two metal reflector plates.

11. A cooking device according to claim 9, wherein the metal frying plate is in direct contact with the low pressure gas chamber.

12. A cooking device according to claim 9, further comprising a glass plate located between the low pressure gas chamber and the metal frying plate, wherein the glass plate contacts the low pressure gas chamber and the metal frying plate.

13. (canceled)

14. A cooking device according to claim 9, wherein the metal frying plate has a sunken region for collecting liquid.

15. A cooking device according to claim 9, wherein the metal frying plate has one or more sunken sausage-receiving portions having a rounded half-cylindrical shape.

16. (canceled)

17. (canceled)

18. (canceled)

19. A cooking device according to claim 9, wherein the metal cover has a hole for allowing water vapour to escape the food-receiving region, the hole having a maximum width of less than 1 mm.

20. (canceled)

21. (canceled)

22. A cooking device according to claim 1, wherein the low pressure gas chamber is filled with air, or nitrogen, or oxygen, or argon, or a mixture of air and argon, or a mixture of nitrogen and argon.

23. (canceled)

24. A cooking device according to claim 1, wherein walls of the low pressure gas chamber have a thickness of at least 3 mm and are formed of glass or a glass ceramic.

25. A cooking device according to claim 24, wherein walls of the low pressure gas chamber are formed of Borosilicate glass.

26. (canceled)

27. (canceled)

28. A cooking device according to claim 1, wherein the low pressure gas chamber is encapsulated in a high-temperature-resistant thin film.

29. A cooking device according to claim 1, the cooking device further comprising a base formed of dielectric material, wherein the low pressure gas chamber and the plasma igniting means are secured to the base.

30. A cooking device according to claim 29, wherein the microwave resonator comprises two metal reflector plates spaced apart from one another and wherein one of the metal reflector plates is bonded to or embedded within the base.

31. A cooking device according to claim 29, the cooking device further comprising a safety shroud formed of silicone rubber or fluoropolymer, wherein the base, the safety shroud and the cooking enclosure form an enclosure around the low pressure gas chamber.
